(19) United States
(12) Patent Application Publication
(10) Pub. No.: US 2005/0006912 A1
(43) Pub. Date: Jan. 13, 2005

(54) Latch assembly accommodating different door panel structures

(76) Inventor: Tsung-Chung Huang, Chiayi County (TW)

Correspondence Address: LADAS & PARRY LLP, 224 SOUTH MICHIGAN AVENUE, SUITE 1200, CHICAGO, IL, 60604, US

(21) Appl. No.: 10/888,254

(22) Filed: Jul. 9, 2004

(30) Foreign Application Priority Data
Jul. 11, 2003 (TW) 092212850

(51) Int. Cl. E05B 9/00

(52) U.S. Cl. 292/337

(57) ABSTRACT

A latch assembly includes a latch unit which can be used with a circular or rectangular faceplate unit. The circular faceplate unit includes a faceplate, a first casing half integral with the faceplate, a second casing half releaseably attached to the faceplate, and a retention ring disposed around the first and second casing halves which surround a housing of the latch unit. The first and second casing halves have slots to engage bosses projecting from a housing of the latch unit. A backing plate of the rectangular faceplate unit has a tubular wall with an engaging hole. The boss of the housing can be slid axially in the engaging hole and then rotated for engagement therewith.

### CROSS-REFERENCE TO RELATED APPLICATION

This application claims priority of Taiwanese Utility Application No.92212850, filed on Jul. 11, 2003.

### BACKGROUND OF THE INVENTION

1. Field of the Invention

This invention relates to a latch assembly, more particularly to a latch assembly including different types of faceplates adaptable to various door panel structures.

2. Description of the Related Art

It is known in the art to provide a latch assembly incorporating different faceplates such as a circular faceplate mountable on wooden door panel structures, and a rectangular faceplate mountable on metal door panel structures. U.S. Pat. No. 5,094,488 discloses a rectangular faceplate assembly and a circular faceplate assembly which can be attached interchangeably to a latch unit. The rectangular faceplate assembly includes a rectangular faceplate and a backing plate in snap engagement with the rectangular faceplate. Aligned latch holes are formed in the rectangular faceplate and the backing plate for extension of the latch unit therethrough. The backing plate is further provided with two raised slots for insertion of two ear tabs of a latch housing and spring tabs to lock the ear tabs. The circular faceplate assembly includes a circular faceplate with means for engaging slidably the latch unit, and locking means for locking the latch unit against the circular faceplate.

U.S. Pat. No. 5,308,131 discloses a latch unit which has two diametrically opposed protrusions that can be clamped between a backing plate and a rectangular faceplate. The protrusions are clamped between the backing plate and the faceplate after passing through two slots formed in the backing plate and after being rotated to move away from the slots. A circular faceplate assembly to be used with this latch unit includes a circular faceplate and a sleeve made of two or more segments to surround the latch unit.

U.S. Pat. No. 5,458,382 discloses a rectangular faceplate and a backing plate which has recesses to receive tabs of a latch unit, and a circular faceplate to surround the latch unit. The circular faceplate is formed with an aperture which can be aligned with a radial threaded bore in the latch unit so that the circular faceplate can be screwed to the latch unit.

U.S. Pat. No. 6,386,603 discloses a latch bolt unit and a rectangular faceplate which is mounted around a housing of the latch bolt unit and positioned between a flange and protrusions formed on the housing. A circular faceplate disclosed therein includes a sleeve of substantially C-shaped cross-section.

### SUMMARY OF THE INVENTION

The object of the present invention is to provide an improved latch assembly which accommodates different door panel structures and which can be assembled and disassembled easily.

According to this invention, a latch assembly comprises a latch unit, a circular faceplate unit and a rectangular faceplate unit, wherein the latch unit is used in combination with one of the circular and rectangular faceplate units which is selected according to the type of the door panel structure to which the latch unit is to be attached.

The latch unit includes a housing, a latch bolt mounted inside the housing, and at least one boss projecting outward from the housing. The circular faceplate unit includes: a front faceplate which has a latch opening, a periphery extending around the latch opening, a first casing half which is formed as one piece with the front faceplate and which projects rearwardly from the periphery, and a flange which projects rearwardly from the periphery opposite to the first casing half; a second casing half cooperating with the first casing half to surround the housing and attached removably to the flange, at least one of the first and second casing halves having an engaging slot to engage the boss; and a retention ring disposed around the first and second casing halves.

The rectangular faceplate unit includes: a front faceplate having a latch opening, and a backing plate which has a latch opening, a tubular wall projecting rearwardly from the backing plate and having a rear end, and an engaging hole formed in the tubular wall for engaging the boss. The engaging hole includes a first hole section that extends circumferentially in the tubular wall, and a second hole section that extends axially from the first hole section and opens at the rear end of the tubular wall, the boss sliding through the second hole section and engaging the first hole section.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded view of a latch unit in combination with a circular faceplate unit to form an assembly according to the present invention;

FIG. 2 is a sectional view taken along line 2-2 of FIG. 1;

FIG. 3 is an exploded view of a latch unit in combination with a rectangular faceplate unit to form an assembly according to the present invention;

FIG. 4 is an exploded view of a latch unit in combination with another rectangular faceplate unit to form an assembly according to the present invention;

FIG. 5 is a fragmentary view of one type of door panel structure;

FIG. 6 is a fragmentary view of another type of door panel structure; and

FIG. 7 is a fragmentary view of still another type of door panel structure.

### DETAILED DESCRIPTION OF THE PREFERRED EMBODIMENTS

Before the present invention is described in greater detail, it should be noted that same reference numerals have been used to denote like elements throughout the specification.

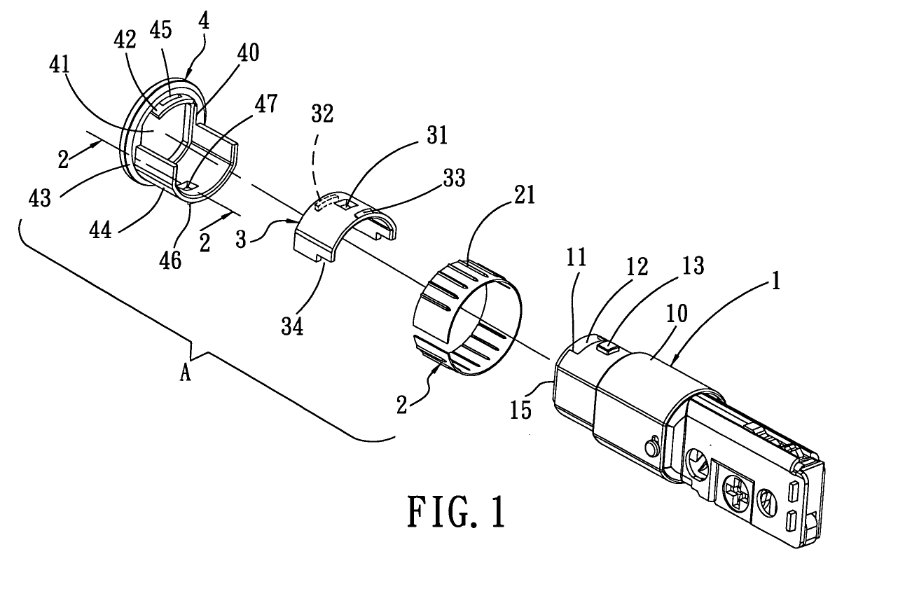

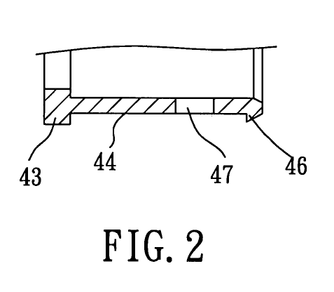

Referring to FIGS. 1 and 2, a preferred embodiment of the latch assembly according to the present invention includes a latch unit 1 which includes a housing 10, and a latch bolt 15 mounted movably inside the housing 10 for moving in an axial or longitudinal direction of the latch bolt 15. A pair of bosses 13 project radially outward from two diametrically opposed positions of the housing 10. The housing 10 further has a recess 12 in an outer surface thereof adjacent to the front end 11 of the housing 10.

A circular faceplate unit (A) in this embodiment includes a front circular faceplate 4 which has a latch opening 41, a periphery 40 extending around the latch opening 41, a first casing half 44 which is formed as one piece with the faceplate 4 and which projects axially and rearwardly from the periphery 40, and a flange 42 which projects axially and rearwardly from the periphery 40 opposite to the first casing half 44. The flange 42 is formed with a circumferentially extending aperture 45. An annular projection 43 extends radially and outwardly from the periphery 40.

A second casing half 3 is placed over and attached to the flange 42 opposite to the first casing half 44. The second casing half 3 projects rearwardly and axially from the flange 42 to cooperate with the first casing half 44 so as to surround the housing 10 of the latch unit 1. A first tab 32 projects from a front end of the second casing half 3 to engage the aperture 45. An engaging slot 31 is formed in the second casing half 3 to engage one of the bosses 13 of the housing 10. Another engaging slot 47 is formed in the first casing half 44 to engage the other boss 13 of the housing 10. The first and second casing halves 44 and 3 have rear ends formed respectively with second tabs 46 and 33.

A retention ring 2 is disposed around the first and second casing halves 44 and 3. A plurality of ridges 21 are formed on an outer surface of the retention ring 2 for engagement with an inner surface of a bore (not shown) provided in a door panel to which the latch assembly is to be attached. Alternatively, protuberances may be formed on the retention ring 2 in place of the ridges 21.

In assembly, the housing 10 is inserted between the flange 42 and the first casing half 44 with the flange 42 being received in the recess 12 of the housing 10. The engaging slot 47 is engaged with the lower boss 13 (not visible) at the bottom side of the housing 10. The second casing half 3 is disposed over the housing 10 with the front end of the second casing half 3 extending over the flange 42. The first tab 32 is inserted into the aperture 45 of the flange 42. In addition, the engaging slot 31 is placed in engagement with the upper boss 13. The retention ring 2 is disposed around the first and second casing halves 44 and 3 and positioned between the annular projection 43 and the second tabs 33 and 46.

In case the circular faceplate 4 is to be disassembled from the housing 10, the retention ring 2 must be first removed from the first and second casing halves 44 and 3. Then, the second casing half 3 can be detached by inserting the tip of a screw driver into a notch 34 formed in the second casing half 3 to push the second casing half 3 away from the first casing half 44.

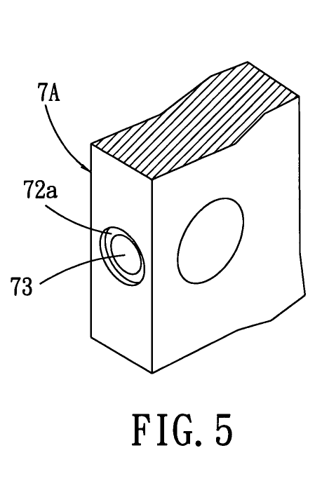

Referring to FIG. 5 in combination with FIG. 1, the latch unit 1 can be mounted on a door panel 7A which has a bore 73 thereinside and a circular mortised recess 72a when the latch unit 1 is attached to the circular faceplate unit (A). In this case, the circular faceplate 4 is received in the recess 72a. The retention ring 2 is engageable with the inner surface of the bore 73 and permits the housing 10 to rotate relative to the retention ring 2 so as to facilitate mounting of a lock assembly.

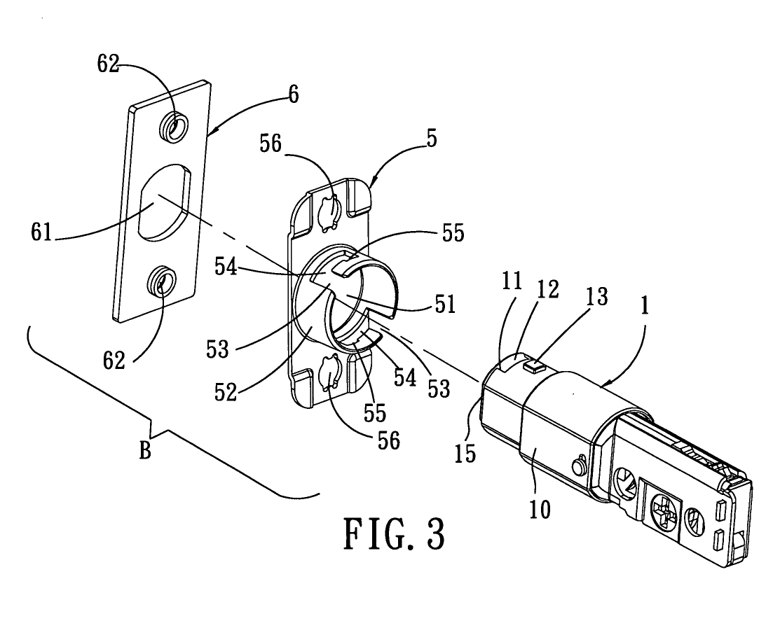

Referring to FIG. 3, a rectangular faceplate unit (B) in this embodiment includes a front rectangular faceplate 6 with four right-angled corners. The rectangular faceplate 6 includes a latch opening 61 and a pair of sockets 62 projecting from the faceplate 6. A backing plate 5 is formed with two holes 56 and is attached to the faceplate 6 by snap engagement of the sockets 62 with the respective holes 56.

The backing plate 5 further includes a latch opening 51, and a tubular wall 52 which projects rearwardly from the backing plate 5 around the latch opening 51. For engagement with the bosses 13 of the housing 10, the tubular wall 52 is formed with a pair of engaging holes each having a first hole section 54 that extends circumferentially in the tubular wall 52, and a second hole section 53 that extends axially from one end of the first hole section 54 and opens at a rear end of the tubular wall 52. Another end of the first hole section 54 has a retaining section 55 to engage and retain the corresponding boss 13.

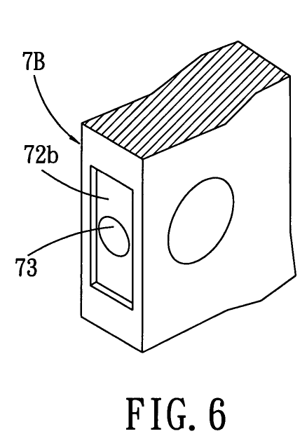

Referring to FIG. 6 in combination with FIG. 3, when the latch unit 1 is combined with the rectangular faceplate unit (B), the latch unit 1 can be mounted on a door panel 7B which has a bore 73 and a rectangular mortised recess 72b. In assembly, the housing 10 is attached to the backing plate 5 by inserting the housing 10 into the tubular wall 52 and by inserting the bosses 13 axially into the second hole sections 53. The housing 10 is then rotated to slide the bosses 13 circumferentially in the respective first hole sections until the bosses 13 are engaged in the respective retaining sections 55. Thereafter, the rectangular faceplate 6 is attached to the backing plate 5 by snap engagement of the sockets 62 and the holes 56. The housing 10 is then inserted into the bore 73, whereas the rectangular faceplate 6 and the backing plate 5 are received in the recess 72b and attached to the door panel 7B by using screws (not shown) which are threaded into the door panel 7B through the faceplate 6 and the backing plate 5.

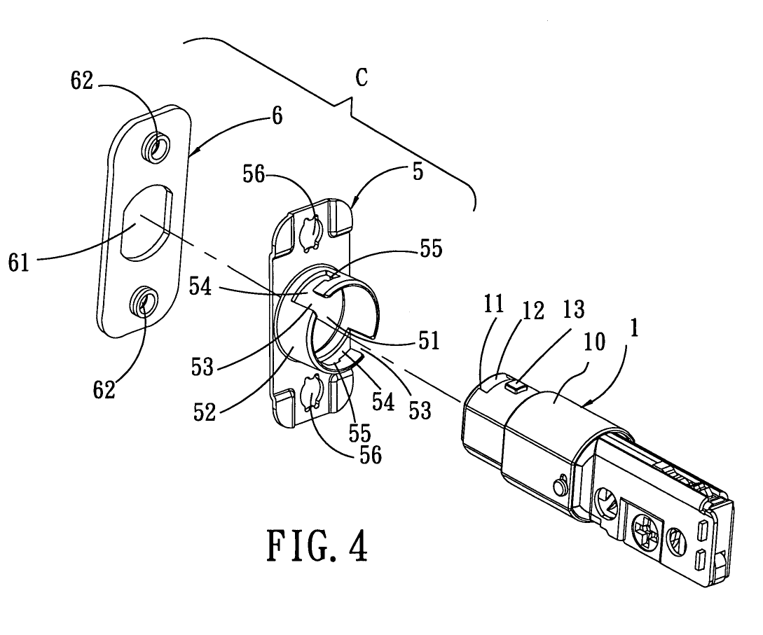

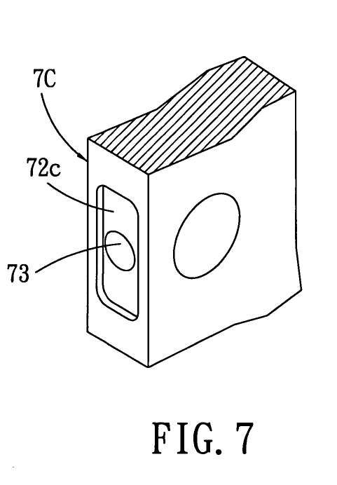

FIG. 4 shows another rectangular faceplate assembly (C) which is substantially similar to that shown in FIG. 3 except that the rectangular faceplate 6a in FIG. 4 has four rounded corners. When the latch unit1 is combined with the rectangular faceplate assembly (C), it can be mounted on a door panel 7C which has a mortised recess 72c and a bore 73 as shown in FIG. 7.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A latch assembly comprising:
a latch unit including
a housing, a latch bolt mounted inside said housing, and at least one boss projecting outward from said housing;
a circular faceplate unit including
a front faceplate having a latch opening, a periphery extending around said latch opening, a first casing half which is formed as one piece with said front faceplate and which projects rearwardly from said periphery, and a flange which projects rearwardly from said periphery opposite to said first casing half;
a second casing half cooperating with said first casing half to surround said housing and attached removably to said flange, at least one of said first and second casing halves having an engaging slot to engage said boss; and
a retention ring disposed around said first and second casing halves, and
a rectangular faceplate unit including
a front faceplate having a latch opening, and
a backing plate having a latch opening, a tubular wall projecting rearwardly from said backing plate and having a rear end, and an engaging hole formed in said tubular wall for engaging said boss, said engaging hole having a first hole section that extends circumferentially in said tubular wall, and a second hole section that extends axially from said first hole section and opens at said rear end of said tubular wall, said boss sliding through said second hole section so as to engage said first hole section,
wherein said latch unit is attached to a selected one of said circular and rectangular faceplate units.

2. A latch assembly comprising:
a latch unit including
a housing, a latch mounted inside said housing, and at least one boss projecting outward from said housing; and
a circular faceplate unit including
a front faceplate having a latch opening, a periphery extending around said latch opening, a first casing half which is formed as one piece with said front faceplate and which projects rearwardly from said periphery, and a flange which projects rearwardly from said periphery opposite to said first casing half;
a second casing half cooperating with said first casing half to surround said housing and attached removably to said flange, at least one of said first and second casing halves having an engaging slot to engage said boss; and
a retention ring disposed around said first and second casing halves.

3. The latch assembly as claimed in claim 2, wherein said latch unit includes a pair of said bosses which are formed on said housing substantially at two opposed positions, said engaging slot being formed in each of said first and second casing halves to engage one of said bosses.

4. The latch assembly as claimed in claim 2, wherein said flange has an aperture formed therein, said second casing half having a front end extending over said flange, and a first tab projecting from said front end to engage said aperture.

5. The latch assembly as claimed in claim 4, wherein said front faceplate further includes a substantially annular projection extending outward from said periphery, said first and second casing halves having rear ends extending away from said front faceplate, and a second tab projecting outward from one of said rear ends of said first and second casing halves, said retention ring being positioned between said annular projection and said second tab.

6. The latch assembly as claimed in claim 4, wherein said front faceplate further includes a substantially annular projection extending outward from said periphery, said first and second casing halves having rear ends extending away from said front faceplate, and second tabs respectively projecting outward from said rear ends of said first and second casing halves, said retention ring being positioned between said annular projection and said second tabs.

7. The latch assembly as claimed in claim 2, wherein said housing has a recess formed in an outer surface of said housing to receive said flange of said front faceplate.

8. A latch assembly comprising:
a latch unit including
a housing, a latch bolt mounted inside said housing, and at least one boss projecting outward from said housing; and
a rectangular faceplate unit including
a front faceplate having a latch opening, and
a backing plate having a latch opening, a tubular wall which projects rearwardly from said backing plate around said latch opening of said backing plate and having a rear end, and at least one engaging hole formed in said tubular wall for engaging said boss, said engaging hole having a first hole section that extends circumferentially in said tubular wall, and a second hole section that extends axially from said first hole section and opens at said rear end of said tubular wall, said boss sliding through said second hole section so as to engage said first hole section.

9. The latch assembly as claimed in claim 8, wherein said rectangular faceplate unit includes a pair of said engaging holes formed in said tubular wall substantially at two opposed positions, said housing having a pair of said bosses for engaging said engaging holes, respectively.

10. The latch assembly as claimed in claim 8, wherein said first hole section has one end formed as a retaining section to engage and retain said boss of said housing, said second hole section being connected to another end of said first hole section opposite to said retaining section.
